(19) United States
(12) Patent Application Publication
(10) Pub. No.: US 2007/0125905 A1
(43) Pub. Date: Jun. 7, 2007

(54) Control apparatus and control method for aircraft

(75) Inventor: Daiki Fukuda, Fuji-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Toyota Jidosha Kabushiki Kaisha

(21) Appl. No.: 11/604,838

(22) Filed: Nov. 28, 2006

(30) Foreign Application Priority Data
Dec. 2, 2005 (JP) 2005-348828

(51) Int. Cl. B64C 15/02

(52) U.S. Cl. 244/23 A

(57) ABSTRACT

The thrust control signal transmitted from the operator of an aircraft is input in both an aircraft control ECU and engine control ECUs that control respective gas-turbine engines such that the engine control ECUs can obtain information concerning the aircraft required output. The engine control ECUs control speeds of the respective gas-turbine engines such that each of the gas-turbine engines half the aircraft required output.

### INCORPORATION BY REFERENCE

The disclosure of Japanese Patent Application No. 2005-348828 filed on Dec. 2, 2005 including the specification, drawings and abstract is incorporated herein by reference in its entirety.

### BACKGROUND OF THE INVENTION

1. Field of the Invention

The invention relates to a control apparatus and method for controlling thrust and attitude of an aircraft provided with multiple gas-turbine-engines.

2. Description of the Related Art

An aircraft is usually provided with multiple engines to ensure safe operation even in the event of an engine failure. With this configuration, even if a failure occurs in one or more engines, the aircraft can continue flying using the remaining engine(s) operating properly.

For example, Published Japanese Translation of PCT Application JP-08-502805 describes a technology related to a helicopter provided with two free turbine-engines. According to the technology, when a failure is detected in one of the two engines, the upper limit of the operable range for the remaining engine is increased in order to enable the aircraft to continue flying using the remaining engine.

In the aircraft that generates thrust required to take off/increase its altitude and fly using compressed air produced by gas-turbine-engines, thrust can be controlled more efficiently if a constant pressure ratio between the pressure of compressed air and the atmospheric pressure (hereinafter, sometimes referred to as the “pressure ratio of compressed air” or “pressure ratio”) is maintained. Accordingly, in such an aircraft, control for maintaining a constant pressure ratio (hereinafter, referred to as “constant pressure ratio control”) may be employed to control the gas-turbine-engines.

However, in the case of a gas-turbine-engine, there are multiple engine operation points at which different outputs are produced at the same pressure ratio. Accordingly, if the constant pressure ratio control is uniformly performed in the multiple gas-turbine-engines using the same pressure ratio as the target pressure ratio, the outputs from the multiple gas-turbine-engines may not always be uniform.

As a result, the mechanical conditions of the gas-turbine-engines may be unbalanced, which reduces redundancy, reliability, safe operation, etc., namely, the advantages offered by providing multiple gas-turbine-engines.

### SUMMARY OF THE INVENTION

An object of the invention is to provide a technology for enabling multiple gas-turbine engines of an aircraft, which are controlled under condition where a constant pressure ratio is maintained, to evenly produce an output.

A first aspect of the invention relates to a control apparatus for an aircraft, including multiple gas-turbine engines; extraction pipes through which compressed air from the respective gas-turbine engines flows; an air collecting pipe in which the compressed air from the extraction pipes is gathered and through which the compressed air flows; a thrust generating device that generates thrust using the compressed air flowing through the air collecting pipe; an attitude control device that controls attitude of the aircraft using the compressed air flowing through the air collecting pipe; a thrust flow-amount control device that controls the amount of compressed air supplied to the thrust generating device; an attitude flow-amount control device that controls the amount of compressed air supplied to the attitude control device; an aircraft control unit that controls the thrust flow-amount control device and the attitude flow-amount control device based on a thrust control signal and an attitude control signal from the operator of the aircraft; and engine control units that control the respective gas-turbine engines. The engine control units can receive the thrust control signal from the operator, and control the respective gas-turbine engines based on the thrust control signal received.

In related art, with a conventional control apparatus for an aircraft, thrust control signals (for example, throttle signals) are transmitted from the operator only to the aircraft control unit. In contrast, according to the first aspect, thrust control signals from the operator are input in both the aircraft control unit and each engine control unit. Thus, each engine control unit can determine the amount of thrust required of the aircraft by the operator. Accordingly, the engine control units can each calculate the total output that is necessary to generate the thrust, and can control the respective gas-turbine engines such that the total output is produced evenly by the multiple gas-turbine engines.

Thus, the multiple gas-turbine engines of the aircraft, which are controlled under condition where a constant pressure ratio is maintained, can evenly produce the output.

A second aspect of the invention relates to a control apparatus for an aircraft, including multiple gas-turbine engines; extraction pipes through which compressed air from the respective gas-turbine engines flows; an air collecting pipe in which the compressed air from the extraction pipes is gathered and through which the compressed air flows; a thrust generating device that generates thrust using the compressed air flowing through the air collecting pipe; an attitude control device that controls attitude of the aircraft using the compressed air flowing through the air collecting pipe; a thrust flow-amount control device that controls the amount of compressed air supplied to the thrust generating device; an attitude flow-amount control device that controls the amount of compressed air supplied to the attitude control device; an aircraft control unit that controls the thrust flow-amount control device and the attitude flow-amount control device based on a thrust control signal and an attitude control signal from the operator of the aircraft; and engine control units that control the respective gas-turbine engines. The engine control units exchange engine control signals with each other, and control the respective gas-turbine engines based on the engine control signals from all the engine control units.

With a conventional control apparatus for an aircraft, each engine control unit controls the corresponding gas-turbine engine independently of the other engine control units. In contrast, according to the second aspect, the engine control units exchange engine control signals with each other. Thus, each engine control unit can determine both the output from the gas-turbine engine under its control (hereinafter, such an engine will be referred to as a “corresponding engine”), and the output(s) from the gas-turbine engine(s) under the control of the other engine control unit(s) (hereinafter, such engine(s) will be referred to as “the other engine(s)”). Therefore, each engine control unit can calculate the total output necessary to generate the thrust that is required of the aircraft by the operator by adding the output from the corresponding engine to the output(s) from the other engine(s).

The engine control units control the respective gas-turbine engines such that the total output is produced evenly by the multiple gas-turbine engines. Thus, the multiple gas-turbine engines of the aircraft, which are controlled under condition where a constant pressure ratio is maintained, can evenly produce the output.

A third aspect of the invention relates to a control apparatus for an aircraft, including multiple gas-turbine engines; extraction pipes through which compressed air from the respective gas-turbine engines flows; an air collecting pipe in which the compressed air from the extraction pipes is gathered and through which the compressed air flows; a thrust generating device that generates thrust using the compressed air flowing through the air collecting pipe; an attitude control device that controls attitude of the aircraft using the compressed air flowing through the air collecting pipe; a thrust flow-amount control device that controls the amount of compressed air supplied to the thrust generating device; an attitude flow-amount control device that controls the amount of compressed air supplied to the attitude control device; an aircraft control unit that controls the thrust flow-amount control device and the attitude flow-amount control device based on a thrust control signal and an attitude control signal from the operator of the aircraft; and engine control units each of which determines the total output from the multiple gas-turbine engines, and which control the respective gas-turbine engines based on the total output. According to the third aspect, the multiple gas-turbine engines of the aircraft, which are controlled under condition where a constant pressure ratio is maintained, can evenly produce the output.

A fourth aspect of the invention relates to a control method for an aircraft provided with multiple gas-turbine engines and engine control units that control the respective gas-turbine engines. The control method for an aircraft includes a step in which a thrust control signal from the operator of the aircraft is input in each of the engine control units; and a step in which the engine control units control the respective gas-turbine engines based on the thrust control signal received.

With the control apparatus and control method for an aircraft according to the invention, the multiple gas-turbine engines of the aircraft, which are controlled under condition where a constant pressure ratio is maintained, can evenly produce the output. Thus, the conditions of the gas-turbine engines are kept uniform. As a result, redundancy and safe operation offered by the twin-engine configuration can be ensured.

### BRIEF DESCRIPTION OF THE DRAWINGS

The foregoing and further objects, features and advantages of the invention will become apparent from the following description of example embodiments with reference to the accompanying drawings, wherein the same or corresponding portions will be denoted by the same reference numerals and wherein:

FIG. 1 illustrates the view of the appearance of an aircraft according to embodiments of the invention;

FIG. 2 illustrates the schematic view of the configuration of a thrust generator (fan) according to the embodiments of the invention;

FIG. 3 illustrates the schematic view of the configuration of a drive source according to a first embodiment of the invention;

FIG. 4 illustrates the view showing a flow of compressed air related to the operation of a gas-turbine-engine according to the embodiments of the invention;

FIG. 5 illustrates the graph showing the operating characteristics of the gas-turbine-engine according to the embodiments of the invention;

FIG. 6 illustrates the flowchart of the output control routine for the gas-turbine-engine according to the embodiments of the invention;

FIG. 7 illustrates the graph showing the relationship between the total air flow amount and the speed of the gas-turbine-engine according to the first embodiment of the invention;

FIG. 8 illustrates the flowchart of the aircraft required output calculation subroutine according to the first embodiment of the invention;

FIG. 9 illustrates the graph showing the relationship between the amount of thrust indicated by a thrust control signal and the aircraft required output according to the first embodiment of the invention;

FIG. 10 illustrates the flowchart of the target total air flow amount calculation subroutine according to the embodiments of the invention;

FIG. 11 illustrates the flowchart showing the turbine-side air flow amount calculation subroutine according to the embodiments of the invention;

FIG. 12 illustrates the flowchart of the fuel injection amount calculation subroutine according to the embodiments of the invention;

FIG. 13 illustrates the view of a fuel injection control system according to the embodiments of the invention;

FIG. 14 illustrates the schematic view of the configuration of a drive source according to a second embodiment of the invention; and

FIG. 15 illustrates the flowchart of the aircraft required output calculation subroutine according to the second embodiment of the invention.

### DETAILED DESCRIPTION OF THE EXAMPLE EMBODIMENTS

Hereafter, example embodiments of the invention will be described in detail with reference to accompanying drawings. The scope of the invention is not limited by sizes, materials, shapes, relative configuration, etc. of components described in the embodiments, unless otherwise specified.

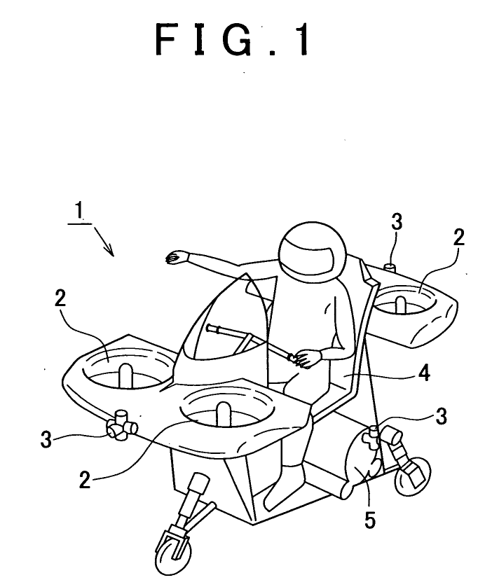

FIG. 1 illustrates an aircraft 1 according to the example embodiments of the invention. As shown in FIG. 1, the aircraft 1 includes two thrust generators (hereinafter, referred to as “fans”) 2, which are provided at the front and rear of the aircraft 1, respectively. The aircraft 1 also includes four reaction jet nozzles (hereinafter, referred to as “nozzles”) 3, which are provided at the front and rear, and on the right and left of the aircraft 1, respectively. The aircraft 1 further includes a drive source 5 provided below an occupant seat 4.

The fan 2 is driven by compressed air, and generates thrust applied substantially vertically upward with respect to the aircraft 1. The nozzle 3 is used to change attitude of the aircraft 1 using a reaction force obtained by emitting the compressed air into the atmosphere. The drive source 5 produces compressed air used to drive the nozzles 3 and the fans 2.

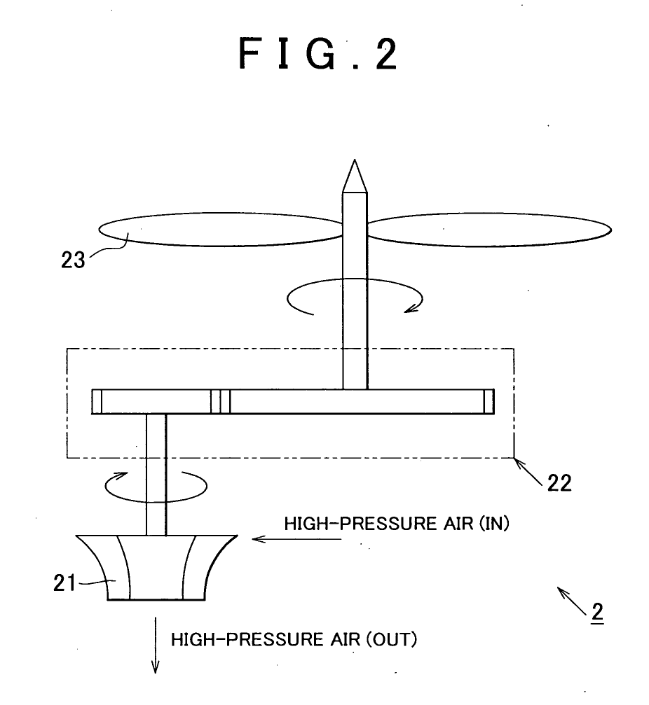

FIG. 2 illustrates the schematic view of the configuration of the fan 2. The fan 2 mainly includes a turbine 21, a reducer 22, and a thrust generating fan 23. The compressed air is introduced to the turbine 21, and expands. The turbine 21 is driven using the energy generated due to expansion of the compressed air. Then, the speed of the turbine 21 is reduced to an appropriate speed by the reducer 22, the rotation of the turbine is then transmitted to the thrust generating fan 23, and the thrust generating fan 23 turns at a high speed. The fan 23 turns at the high speed and generates an airflow flowing downward of the aircraft 1, whereby thrust, which is applied substantially vertically upward with respect to the aircraft 1, is generated. The aircraft 1 can fly and vertically take off/and using thrust thus generated.

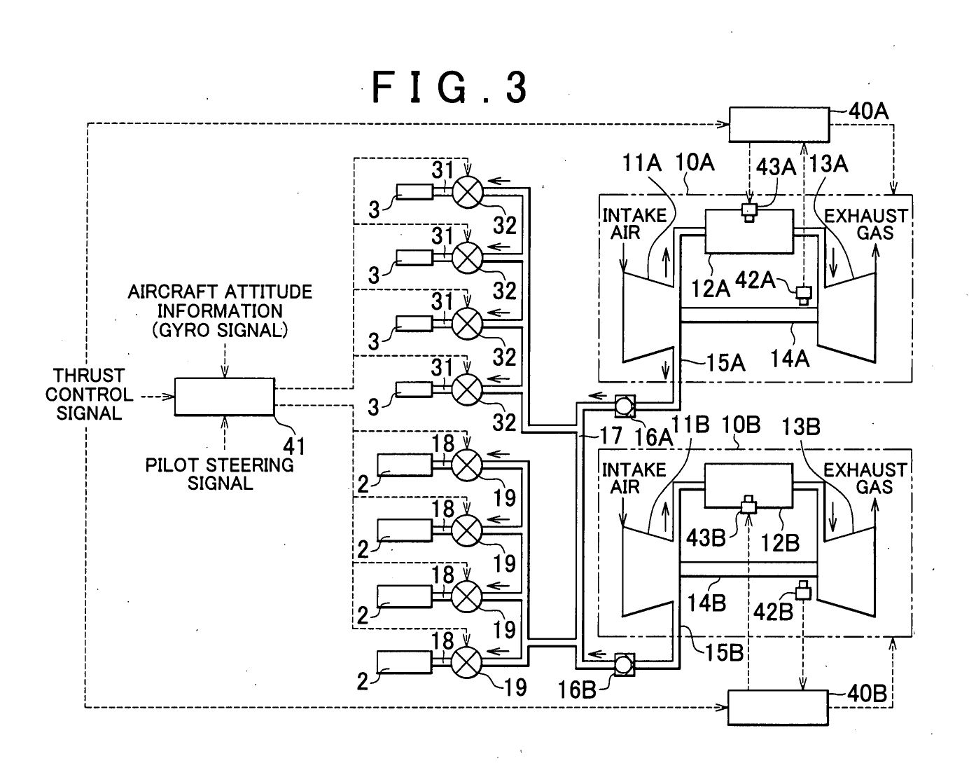

FIG. 3 illustrates the schematic view of the configuration of the drive source 5. The drive source 5 is provided with two uniaxial gas-turbine-engines, namely, a first gas-turbine-engine 10A and a second gas-turbine-engine 10B. The twin-engine configuration is employed as the drive source 5. With the twin-engine configuration, even if a failure occurs in one of the two engines, the output required for the aircraft 1 can be produced using only the remaining engine. Employment of the twin-engine configuration improves the operational safety of the aircraft 1. In the following description concerning the functions and components common to both the first gas turbine-engine 10A and the second gas turbine-engine 10B, the first gas turbine-engine 10A and the second gas turbine-engine 10B will be collectively referred to as the “gas-turbine-engine(s) 10” unless such expression leads to confusion and misinterpretation.

The gas-turbine-engine 10 includes a compressor 11, a combustion chamber 12, and a turbine 13. The compressor 11 and the turbine 13 are connected to each other via a rotating shaft 14. The air taken in the compressor 11 is compressed by the compressor 11, and the compressed air is introduced to the combustion chamber 12. In the combustion chamber 12, the compressed air is mixed with the fuel supplied from a fuel injection valve 43 to form an air-fuel mixture, and the air-fuel mixture is burned. The combustion gas having a high-temperature and a high-pressure is used to drive the turbine 13, and then discharged to the outside of the gas-turbine-engine 10.

The fuel injection valve 43 is connected to an engine control ECU 40, described later in detail, for example, via electric wiring. The fuel injection valve 43 injects fuel into the combustion chamber 12 according to control signals transmitted from the engine control ECU 40.

An extraction pipe 15 is connected to the compressor 11. Part of the compressed air produced by the compressor 11 is discharged to the extraction pipe 15 to be used as an engine output. The extraction pipes 15 are connected to an air collecting pipe 17 via a check valve 16. The compressed air discharged from one of the compressors 11 and the compressed air discharged from the other compressor 11 are gathered in the air collecting pipe 17. The check valve 16 permits the compressed air to flow toward the air collecting pipe 17, and prohibits the compressed air from flowing from the air collecting pipe 17 toward the compressor 11. Thus, the compressed air discharged from one of the engines 10 is prevented from affecting the output from the other gas turbine-engine 10.

The output from the gas-turbine-engine 10 is obtained in the form of compressed air, supplied to the nozzles 3 and the fans 2 through the air collecting pipe 17, and used to change attitude of the aircraft 1 and generate thrust.

The air collecting pipe 17 is connected to four thrust air pipes 18. The thrust air pipes 18 are connected to the respective fans 2. A flow amount control valve 19, which can regulate the passage area of the thrust air pipe 18, is provided in each of the thrust air pipes 18. The flow amount of the compressed air introduced to the fan 2 is adjusted by changing the opening amount of the flow amount control valve 19, whereby the amount of thrust generated by the fan 2 can be changed.

For example, when a large amount of thrust is required, for example, when the aircraft 1 takes off or its altitude is increased, the opening amount of the flow amount control valve 19 is increased to introduce a large amount of compressed air to the fan 2. On the other hand, when the amount of thrust needs to be reduced, for example, when the aircraft 1 lands, the opening amount of the flow amount control valve 19 is reduced to decrease the amount of compressed air introduced to the fan 2.

The flow amount control valve 19 is connected to an aircraft control ECU 41, described later in detail, via electric wiring. The opening amount of the flow amount control valve 19 is changed according to control signals transmitted from the aircraft control ECU 41.

When a constant pressure ratio between the pressure of compressed air and the atmospheric pressure (hereinafter, simply referred to as the “pressure ratio of the compressed air” or “pressure ratio”) is maintained, the flow amount of the compressed air introduced from the thrust air pipe 18 to the fan 2 is determined based mainly on the opening amount of the flow amount control valve 19. Accordingly, when a constant pressure ratio of the compressed air is maintained, the amount of thrust generated by the fan 2 can be controlled mainly by adjusting the opening amount of flow amount control valve 19.

Because thrust can be controlled in the above-mentioned manner, the gas-turbine-engine 10 is controlled by performing the control for maintaining a constant pressure ratio of the compressed air (hereinafter, referred to as the “constant pressure ratio control”) in the first embodiment.

Attitude of the aircraft 1 is controlled using the nozzles 3, attitude control air pipes 31, and electromagnetically driven valves 32. The air collecting pipe 17 is connected to the four attitude control air pipes 31. The attitude control air pipes 31 are connected to the respective nozzles 3. The electromagnetically driven valve 32, which can change the amount of compressed air flowing through the attitude control air pipe 31, is provided in each of the attitude control air pipes 31. Attitude of the aircraft is changed by changing the combination of the directions in which the compressed air is emitted, using the electromagnetically driven valves 32.

The electromagnetically driven valves 32 are connected to the aircraft control ECU 41, for example, via electric wiring. The combination of the nozzles 3 that emit compressed air is changed according to control signals transmitted from the aircraft control ECU 41.

The aircraft 1 thus configured is provided with a corresponding engine control ECU 40A that controls the first gas-turbine-engine 10A, the other engine control ECU 40B that controls the second gas-turbine-engine 10B, and the aircraft control ECU 41 that controls thrust and attitude of the aircraft 1.

Each of the engine control ECU 40 and the aircraft control ECU 41 is an electronic control computer unit including a CPU, ROM, RAM, backup RAM, etc.

The gas-turbine-engine 10 is provided with a rotational angle sensor 42 that detects the rotation speed of the rotating shaft 14. In addition to the rotational angle sensor 42, the gas-turbine-engine 10 is provided with various sensors (not shown in FIG. 3) such as a pressure sensor that detects the pressure P0 of the atmospheric air taken in the compressor 11 (hereinafter, referred to as the “atmospheric pressure P0”), a temperature sensor that detects the temperature T0 of the atmospheric air taken in the compressor 11 (hereinafter, referred to as the “atmospheric temperature T0”), a pressure sensor that detects the pressure P3 of the compressed air flowing from the compressor toward the combustion chamber (hereinafter, referred to as the “compressor outlet pressure P3”), a temperature sensor that detects the temperature T3 of the compressed air flowing from the compressor toward the combustion chamber (hereinafter, referred to as the “compressor outlet temperature T3”), and a temperature sensor that detects the temperature T4 of the combustion gas flowing in the turbine (hereinafter, referred to as the “turbine inlet temperature T4”).

These sensors are connected to the engine control ECU 40, for example, via electric wiring. The signals from these sensors are transmitted to the engine control ECU 40. The engine control ECU 40 calculates the amount of fuel to be injected into the combustion chamber 12 according to the preset schedule, based on the signals from the various sensors. The engine control ECU 40 transmits a control signal to the fuel injection valve 43 to supply the calculated amount of fuel from the fuel injection valve 43 into the combustion chamber 12.

The aircraft control ECU 41 receives thrust control signals (e.g., throttle signals) and attitude control signals (e.g., steering signals) from a pilot, information concerning attitude of the aircraft 1 (e.g., gyro signals), etc. The aircraft control ECU 41 transmits control signals to the flow amount control valves 19 and the electromagnetically driven valves 32 based on these signals. Thus, thrust can be generated and attitude of the aircraft 1 can be maintained as desired by the pilot.

Hereafter, the operating characteristics of the gas-turbine-engine 10 will be described in detail.

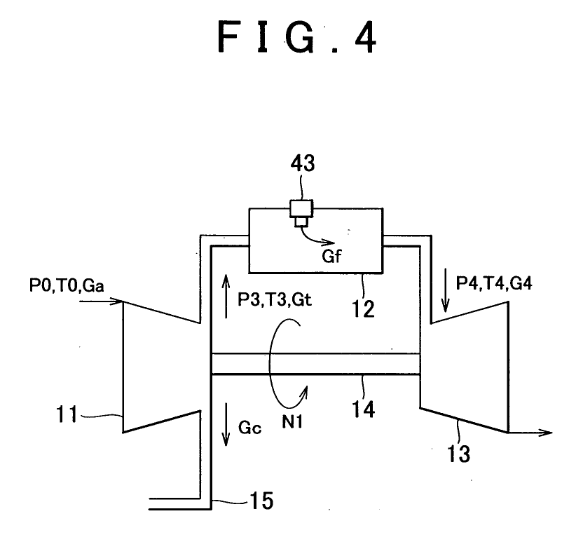

FIG. 4 illustrates the flow of compressed air, which affects the operation of the gas-turbine-engine 10.

The flow amount Ga (hereinafter, referred to as the “total air flow amount) of atmospheric air (atmospheric pressure P0, atmospheric pressure T0) is taken in the compressor 11, and compressed by the compressor 11. Then, the flow amount Gc (hereinafter, referred to as the “extraction flow amount”) of compressed air flowing through the extraction pipe 15 is used as an engine output, and the flow amount Gt (hereinafter, referred to as the “turbine-side air flow amount”) of remaining compressed air (compressor outlet pressure P3, compressor outlet temperature T3) is introduced to the combustion chamber 12. In the combustion chamber 12, the fuel injection amount Gf of fuel is supplied from the fuel injection valve 43, and mixed with the compressed air to form an air-fuel mixture. The air-fuel mixture is burned in the combustion chamber 12. The flow amount G4 (hereinafter, referred to as the “turbine gas flow amount”) of combustion gas (turbine inlet pressure P4, turbine inlet temperature T4) is discharged from the combustion chamber 12, and flows in the turbine 13, whereby the turbine 13 is driven. Thus, the turbine 13 and the compressor 11 operate at the speed N1. The combustion gas that is used to drive the turbine 13 is discharged to the outside of the gas-turbine-engine 10.

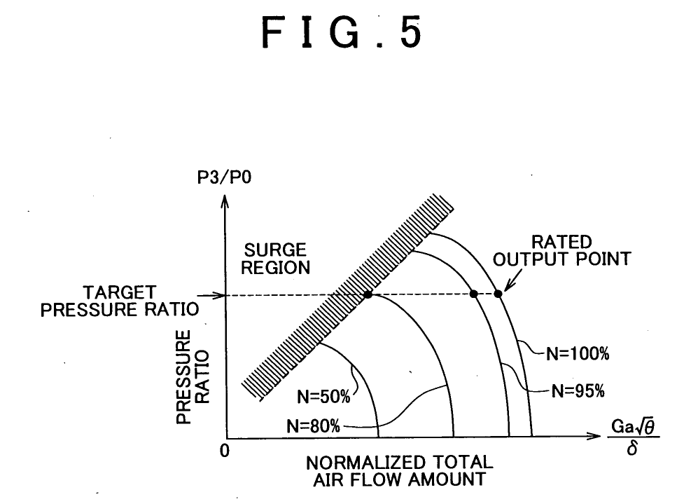

FIG. 5 is the graph showing the operating characteristics of the gas-turbine-engine 10. In FIG. 5, the lateral axis relates to the total air flow amount Ga and the longitudinal axis indicates the pressure ratio P3/P0. In FIG. 5, “δ” indicates the ratio between the atmospheric temperature T0 and the reference atmospheric temperature (atmospheric temperature T0/reference atmospheric temperature), and “δ” indicates the ratio between the atmospheric pressure P0 and the reference atmospheric pressure (atmospheric pressure P0/reference atmospheric pressure). The solid curved lines show the characteristics of the compressor 11 at each speed of the gas-turbine-engine 10, when the rated speed is 100% (N=100%). The hatched area indicates the area in which surging of the compressor occurs.

As shown in FIG. 5, at the target pressure ratio, the operation point at the rated speed is the rated output point (the maximum output point). However, there are multiple operation points at which the pressure ratio is equal to the pressure ratio at the rated output point although the speed and the total air flow amount are different from those at the rated output point. Namely, in the uniaxial gas-turbine-engine where the engine output is obtained in the form of the compressed air, even if the constant pressure ratio control is performed to maintain the pressure ratio at the constant target pressure ratio, the output varies depending on the speed.

Accordingly, as in the first embodiment in which two gas turbine-engines 10 are provided, even if the constant pressure ratio control is uniformly performed in the two gas-turbine-engines 10 using the same target pressure ratio, the two gas-turbine-engines do not always produce the same output. Accordingly, it is difficult to produce the output required for the aircraft 1 (hereinafter, referred to as the “aircraft required output”) always evenly by the two gas-turbine-engines 10. The gas-turbine-engine 10 that produces a greater output deteriorates faster than the other gas-turbine-engine 10. Accordingly, the mechanical conditions of the two gas-turbine-engines 10 may be unbalanced, which reduces redundancy offered by the twin-engine configuration.

In contrast, in the output control for the gas-turbine-engine 10 according to the first embodiment, the engine control ECU 40 can control the target speed based on the aircraft required output. Namely, each engine control ECU 40 can set the target speed such that half the aircraft required output is produced by the gas-turbine-engine 10. Thus, even under the constant pressure ratio control, the two gas-turbine-engines 10 are operated at the same speed. Therefore, the two engines produce the same output. As a result, durability, reliability and redundancy of the two gas-turbine-engines 10 can be ensured.

In order to perform such output control for the gas-turbine-engine 10, the output control routine for the gas-turbine-engine 10 includes a step in which the engine control ECU 40 determines the aircraft required output.

The thrust control signal from the pilot is usually transmitted only to the aircraft control ECU 41. In the first embodiment, however, the thrust control signal is transmitted to the engine control ECU 40 as well as to the aircraft control ECU 41. Thus, the engine control ECU 40 can determine the aircraft required output.

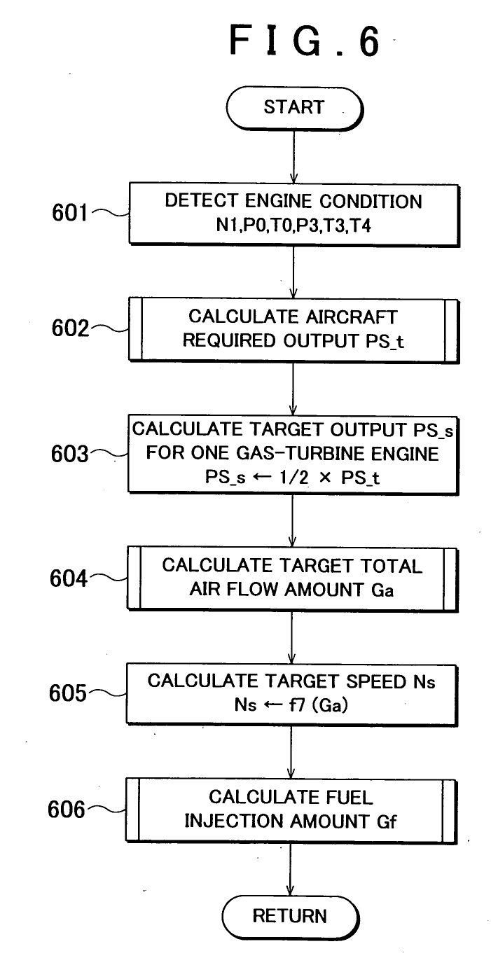

Hereafter, the output control for the gas-turbine-engine 10 according to the first embodiment will be described with reference to the flowchart in FIG. 6.

FIG. 6 illustrates the flowchart of the routine for performing the output control for the gas-turbine-engine 10 (hereinafter, referred to as the “main routine”). The routine in FIG. 6 is periodically performed by the engine control ECU 40 at predetermined time intervals.

First, in step 601, the engine control ECU 40 detects the condition of the gas-turbine-engine 10. More specifically, the engine control ECU 40 receives signals indicating the speed N1 of the gas-turbine-engine 10, the atmospheric pressure P0, the atmospheric temperature T0, the compressor outlet pressure P3, the compressor outlet temperature T3, and the turbine inlet temperature T4 from various sensors such as the rotational angle sensor 42 provided to the gas-turbine-engine 10.

In step 602, the engine control ECU 40 calculates the aircraft required output PS_t. The aircraft required output PS_t is calculated by performing the aircraft required output PS_t calculation subroutine as described later in detail.

In step 603, the engine control ECU 40 calculates the target output PS_s for one gas-turbine-engine 10 based on the aircraft required output PS_t calculated in step 602. In the first embodiment, the target output PS_s for one engine is set to half the aircraft required output PS_t such that the aircraft required output PS_t is produced evenly by the two gas-turbine-engines 10 (PS_s←½×PS_t).

In step 604, the engine control ECU 40 calculates the target total air flow amount Ga corresponding to the target output PS_s calculated in step 603. The target total air flow amount Ga is calculated by performing the target total air flow amount Ga calculation subroutine as described later in detail.

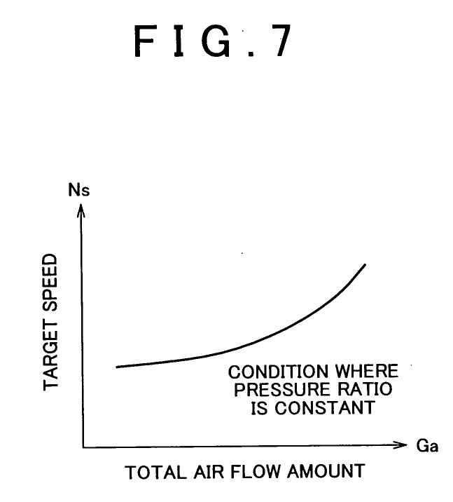

In step 605, the engine control ECU 40 calculates the target speed Ns based on the operating characteristics of the gas-turbine-engine 10 in FIG. 5, using the target total air flow amount Ga calculated in step 604 (Ns←f7(Ga)). The function f7 is used to calculate the target speed Ns corresponding to the target total air flow amount Ga under the condition where a constant pressure ratio is maintained, based on the operating characteristics of the gas-turbine-engine 10 in FIG. 5. FIG. 7 illustrates the graph showing the relationship between the target total air flow amount Ga and the target speed Ns under the condition where a constant pressure ratio is maintained. In FIG. 7, the lateral axis indicates the total air flow amount Ga, and the longitudinal axis indicates the target speed Ns. The function f7 is obtained, in advance, using the graph in FIG. 5. The function f7 is stored in the ROM of the engine control ECU 40 as the function or the map used to calculate the target speed Ns based on the target total air flow amount Ga.

In step 606, the engine control ECU 40 corrects the amount Gf of fuel injected from the fuel injection valve 43 into the combustion chamber 12 based on the difference between the target speed Ns calculated in step 605 and the current speed N1 detected in step 601 that is the first step in the main routine. Thus, each gas-turbine-engine 10 is operated at the target speed Ns. The fuel injection amount Gf is calculated by performing the fuel injection amount Gf calculation subroutine as described later in detail.

The outline of the output control for the gas-turbine-engine 10 according to the first embodiment has been described so far.

Hereafter, the subroutines performed in the corresponding steps of the main routine will be described in detail.

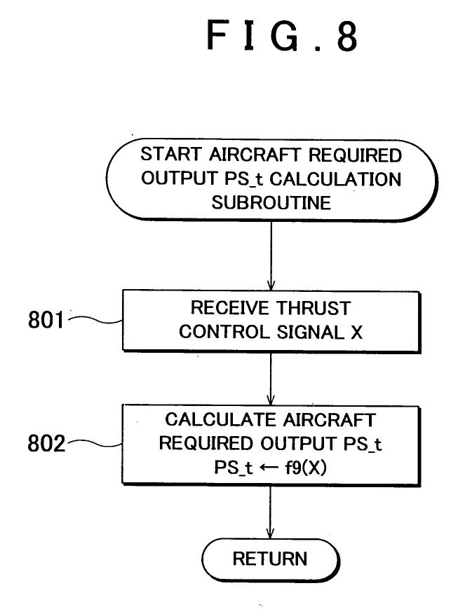

FIG. 8 illustrates the flowchart of the aircraft required output PS_t calculation subroutine.

First, in step 801, the engine control ECU 40 receives the thrust control signal X. The thrust control signal X is transmitted from the pilot to the engine control ECU 40 as well as to the aircraft control ECU 41. The thrust control signal X indicates the amount of thrust required of the aircraft by the pilot. An example of the thrust control signal is a throttle signal.

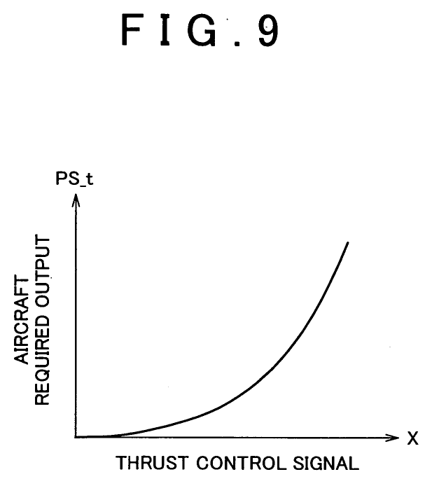

In step 802, the engine control ECU 40 calculates the aircraft required output PS_t based on the thrust control signal X received in step 801 (PS_t←f9(X)). The function f9 is used to calculate the aircraft required output PS_t according to the thrust control signal X. FIG. 9 illustrates the graph showing the relationship between the amount of thrust indicated by the thrust control signal X and the aircraft required output PS_t. In FIG. 9, the lateral axis indicates the amount of thrust indicated by the thrust control signal X, and the longitudinal axis indicates the aircraft required output PS_t. The function f9 is empirically determined. The function f9 is stored in the ROM of the engine control ECU 40 as the function or the map used to calculate the aircraft required output PS_t based on the thrust control signal X.

The engine control ECU 40 calculates the aircraft required output PS_t, after which the subroutine ends.

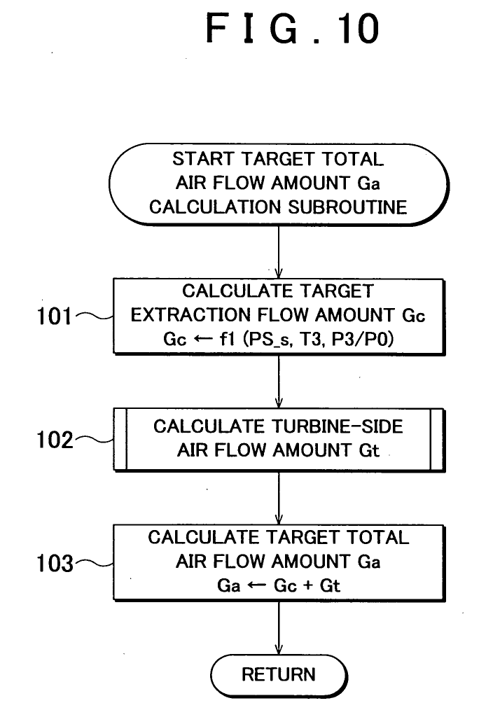

FIG. 10 illustrates the flowchart of the target total air flow amount Ga calculation subroutine.

First, in step 101, the engine control ECU 40 calculates the target extraction flow amount Gc. More specifically, the engine control ECU 40 converts the target output PS_s for one gas-turbine-engine 10 calculated in step 603 into the flow amount (extraction flow amount Gc) of the compressed air to be obtained from the extraction pipe 15. The equation used to convert the target output PS_s into the extraction flow amount Gc is theoretically obtained, and expressed as follows.

$$\begin{matrix}Gc = f 1 ( PS\_s , T 3 , P 3 / P 0 ) \\ = \frac{75}{J} \cdot \frac{1}{Cp} \cdot PS\_s \cdot \frac{1}{T 3} {\{ 1 - \frac{1}{{( \frac{P 3}{P 0} )}^{\frac{κ - 1}{κ}}} \}}^{- 1}\end{matrix} \qquad ( 1 )$$

In the equation 1, “J” indicates the mechanical equivalent of heat, “Cp” indicates the specific heat, “K” indicates the ratio of specific heat, “P3/P0” indicates the pressure ratio, “T3” indicates the compressor outlet temperature, “Gc” indicates the extraction flow amount, and “PS_s” indicates the target output for one gas-turbine-engine 10. The equation (1) is stored in the ROM of the engine control ECU 40 as the function f1 or the map used to calculate the target extraction flow amount Gc based on the target output PS_s, the compressor outlet temperature T3 and the pressure ratio P3/P0. The engine control ECU 40 calculates the target extraction flow amount Gc based on the function f1 or the map (Gc←f1(PS_s, T3, P3/P0)).

In step 102, the engine control ECU 40 calculates the turbine-side air flow amount Gt. The turbine-side air flow amount Gt is calculated by performing a turbine-side air flow amount Gt calculation subroutine as described later in detail.

In step 103, the engine control ECU 40 calculates the target total air flow amount Ga. As shown in FIG. 4, part of the compressed air produced by the compressor 11 (extraction flow amount Gc) is obtained from the extraction pipe 15 and used as an engine output, and the remaining compressed air (turbine-side air flow amount Gt) is introduced to the combustion chamber 12 to form an air-fuel mixture to be burned. Accordingly, the target total air flow amount Ga can be calculated by adding the turbine-side air flow amount Gt calculated in step 102 to the target extraction flow amount Gc calculated in step 101 (Ga←Gc+Gt).

The engine control ECU 40 calculates the target total air flow amount Ga, after which the subroutine ends.

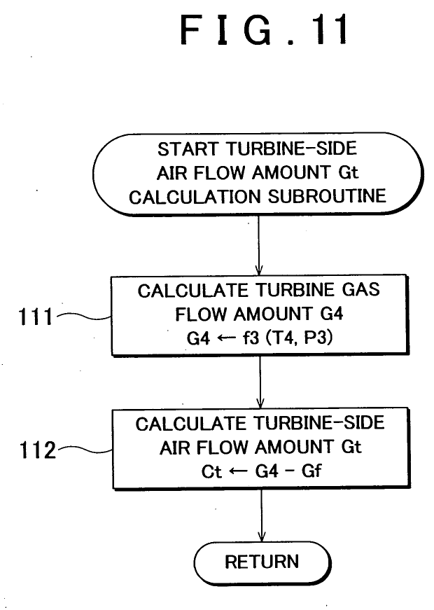

FIG. 11 illustrates the flowchart of the turbine-side air flow amount Gt calculation subroutine.

First, in step 111, the engine control ECU 40 calculates the turbine gas flow amount G4. The turbine gas flow amount G4 is expressed by the following equation (2).

$$\begin{matrix}Q 4 = \frac{G 4 \sqrt{T 4}}{P 4} \\ ≅ \frac{G 4 \sqrt{T 4}}{P 3} \\ ≅ Constant value\end{matrix} \qquad ( 2 )$$

In the equation (2), “Q4” indicates the turbine flow amount coefficient, “G4” indicates the turbine gas flow amount, “T4” indicates the turbine inlet temperature, “P4” indicates the turbine inlet pressure, and “P3” indicates the compressor outlet pressure. The turbine flow amount coefficient Q4 is a value specific to the turbine. The turbine flow amount coefficient Q4 changes depending on the expansion rate of the combustion gas in the turbine. However, in the operating range of the gas-turbine-engine 10 according to the first embodiment, a substantially constant turbine flow amount coefficient Q4 is maintained.

The turbine flow amount coefficient Q4 is defined by the first formula in the equation (2). In the gas-turbine-engine 10 according to the first embodiment, the compressor outlet pressure P3 and the turbine inlet pressure P4 are substantially equal to each other. This is because, even if fuel is supplied from the fuel injection valve 43 into the combustion chamber 12, the pressure of compressed air hardly changes between before and after the compressed air passes through the combustion chamber 12. Accordingly, the turbine inlet pressure P4 is approximately equal to the compressor outlet pressure P3, based on which the second formula in the equation (2) is established.

Thus, the relationship between the turbine inlet temperature T4 and the compressor outlet pressure P3, and the turbine gas flow amount G4 is expressed by the following equation (3).

$$\begin{matrix}G 4 = f 3 ( T 4 , P 3 ) \\ = \frac{Q 4 \cdot P 3}{\sqrt{T 4}}\end{matrix} \qquad ( 3 )$$

The equation (3) is stored in the ROM of the engine control ECU 40 as the function f3 or the map that is used to calculate the turbine gas flow amount G4 based on the turbine inlet temperature T4 and the compressor outlet pressure P3. The engine control ECU 40 calculates the turbine gas flow amount G4 based on the function f3 or the map (G4←f3(T4, P3)).

In step 112, the engine control ECU 40 calculates the turbine-side air flow amount Gt. The turbine gas flow amount G4 can be considered as the sum of the turbine-side air flow amount Gt and the fuel injection amount Gf. Accordingly, the turbine-side air flow amount Gt is calculated by subtracting the fuel injection amount Gf, which can be detected according to the control signal currently output from the engine control ECU 40 to the fuel injection valve 43, from the turbine gas flow amount G4 calculated in step 111 (Gt←G4−Gf).

The engine control ECU 40 calculates the turbine-side air flow amount Gt, after which the subroutine ends.

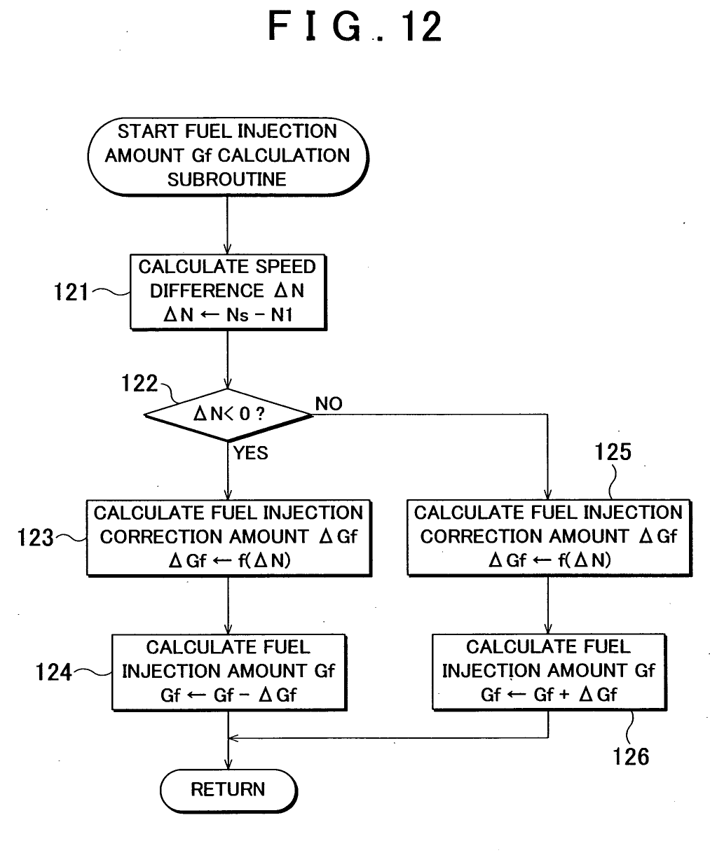

FIG. 12 illustrates the flowchart of the fuel injection amount Gf calculation subroutine.

First, in step 121, the engine control ECU 40 calculates the speed difference ΔN. The speed difference ΔN is the difference between the target speed Ns calculated in step 605 and the current speed N1 of the gas-turbine-engine 10 detected in step 601, namely, the speed difference ΔN is calculated by subtracting the current speed N1 from the target speed Ns (ΔN←Ns−N1).

In step 122, the engine control ECU 40 compares the target speed Ns with the current speed N1. More specifically, the engine control ECU 40 determines whether the speed difference ΔN calculated in step 121 is lower than 0.

If an affirmative determination is made in step 122 (ΔN<0), the engine control ECU 40 determines that the current speed N1 is higher than the target speed Ns. Then, the fuel injection amount is reduced to decrease the speed of the gas-turbine-engine 10. More specifically, in step 123, the engine control ECU 40 calculates the fuel injection correction amount ΔGf corresponding to the speed difference ΔN. In step 124, the engine control ECU 40 calculates the new fuel injection amount Gf by subtracting the fuel injection correction amount ΔGf from the current fuel injection amount Gf.

On the other hand, if a negative determination is made in step 122 (ΔN≧0), the engine control ECU 40 determines that the current speed N1 is lower than the target speed Ns. Then, the fuel injection amount is increased to increase the speed of the gas-turbine-engine 10. More specifically, in step 125, the engine control ECU 40 calculates the fuel injection correction amount ΔGf corresponding to the speed difference ΔN. In step 126, the new fuel injection amount Gf is calculated by adding the fuel injection correction amount ΔGf to the current fuel injection amount Gf.

The engine control ECU 40 calculates the fuel injection amount Gf corresponding to the target speed Ns, after which the subroutine ends.

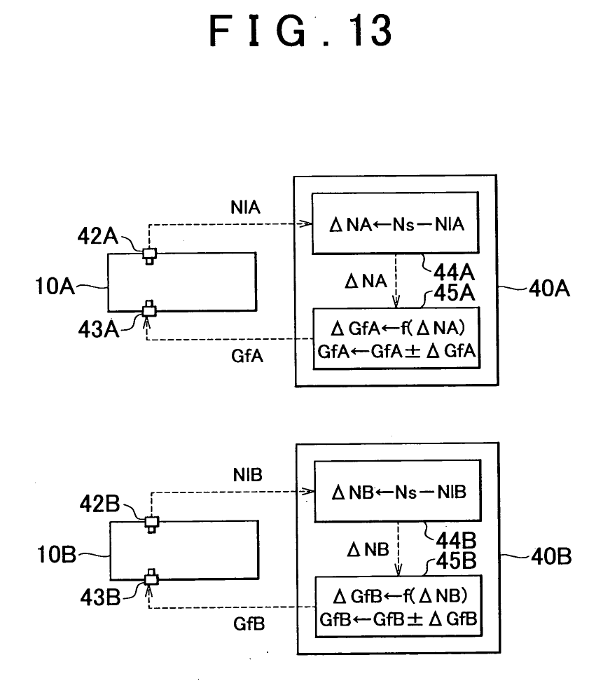

FIG. 13 illustrates the view showing a fuel injection control system that performs the fuel injection amount Gf calculation subroutine.

In FIG. 13, the current speed N1 of the gas-turbine-engine 10 is detected by the speed sensor 42 provided to the gas-turbine-engine 10, and transmitted to a speed difference calculator 44. The speed difference calculator 44 calculates the difference ΔN between the current speed N1 and the target speed Ns, and transmits the result of calculation to a fuel injection amount calculator 45. The fuel injection amount calculator 45 calculates the fuel injection correction amount ΔGf based on the speed difference ΔN. When the speed difference ΔN is lower than 0, the fuel injection amount calculator 45 calculates the new fuel injection amount Gf by subtracting the fuel injection correction amount ΔGf from the current fuel injection amount Gf. On the other hand, when the speed difference ΔN is equal to or higher than 0, the fuel injection amount calculator 45 calculates the new fuel injection amount Gf by adding the fuel injection correction amount ΔGf to the current fuel injection amount Gf. The engine control ECU 40 transmits the control signal to the fuel injection valve 43 to perform fuel injection using the new fuel injection amount Gf.

When the ECU 40 performs the output control, the gas turbine-engines 10 are operated at the same speed even under the constant pressure ratio control. Thus, the aircraft required output can be produced evenly by the two gas-turbine-engines 10.

Next, a second embodiment of the invention will be described. The second embodiment is different from the first embodiment only in the manner in which the engine control ECU 40 determines the aircraft required output. Accordingly, the same or corresponding portions as/to those in the first embodiment will not be described below.

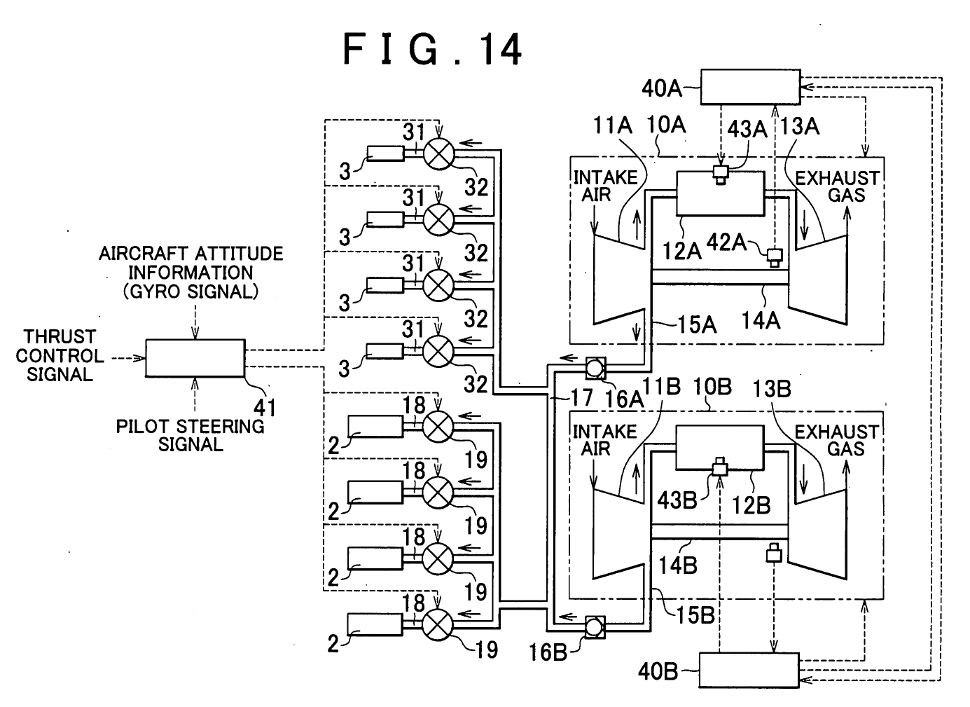

FIG. 14 illustrates the schematic view of the configuration of the drive source 5 according to the second embodiment. The drive source 5 according to the second embodiment differs from the drive source 5 according to the first embodiment in that the thrust control signal from the pilot is not input in the engine control ECU 40 and input only in the aircraft control ECU 41 as in related art. However, the engine control ECUs 40 can exchange information concerning the output control for the gas turbine-engines 10 controlled by the respective engine control ECUs 40.

Namely, the corresponding engine control ECU 40A transmits the output control signal for the first gas-turbine-engine 10A to the other engine control ECU 40B, and, in turn, receives the output control signal for the second gas-turbine-engine 10B that is transmitted from the other engine control ECU 40B. Similarly, the other engine control ECU 40B transmits the output control signal for the second gas-turbine-engine 10B to the corresponding engine control ECU 40A, and, in turn, receives the output control signal for the first gas-turbine-engine 10A that is transmitted from the corresponding engine control ECU 40A.

Thus, each engine control ECU 40 can determine the output from the gas-turbine-engine 10 that is under its control (hereinafter, such gas-turbine-engine 10 is referred to as the “corresponding-engine”) and the information concerning the output from the gas-turbine-engine 10 that is under control of the other engine control ECU 40 (hereinafter, such gas-turbine-engine 10 is referred to as “the other engine”). Therefore, each engine control ECU 40 can calculate the aircraft required output by adding the output from the corresponding-engine and the output from the other engine.

The output control routine for the gas-turbine-engine 10 performed by the engine control ECU 40 according to the second embodiment is the same as that according to the first embodiment except for the contents of the aircraft required output PS_t calculation subroutine performed in step 602 in the main routine in FIG. 6.

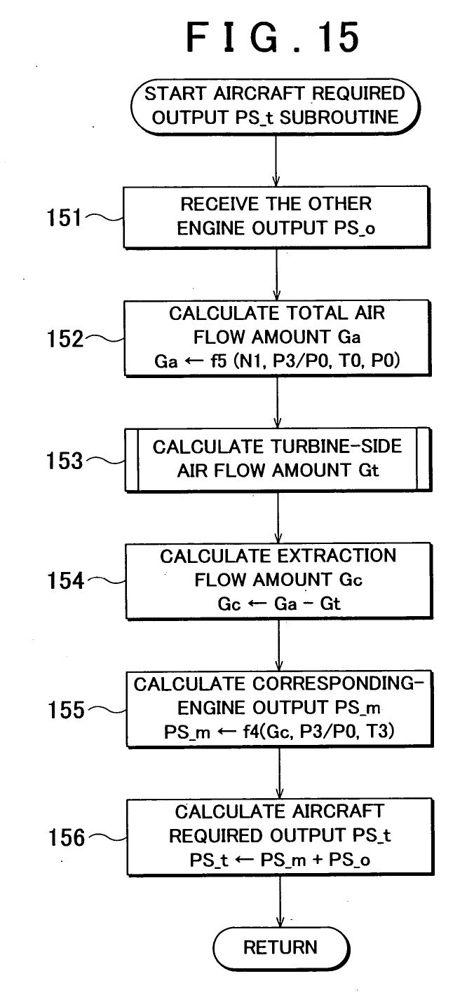

Hereafter, the aircraft required output PS_t calculation subroutine according to the second embodiment will be described with reference to the flowchart in FIG. 15.

First, in step 151, the engine control ECU 40 detects the output PS_o from the other engine. The engine control unit ECU 40 receives the output control signal indicating the output PS_o transmitted from the other engine control ECU 40.

In step 152, the engine control ECU 40 calculates the total air flow amount Ga. More specifically, the engine control ECU 40 calculates the total air flow amount Ga based on the operating characteristics of the gas-turbine-engine in FIG. 5, using the current speed N1 of the gas-turbine-engine 10, the pressure ratio P3/P0, the atmospheric temperature T0, and the atmospheric pressure P0 (Ga←f5(N1, P3/P0, T0, P0)). The function f5 is used to calculate the total air flow amount Ga corresponding to the speed N1 under the condition where a constant pressure ratio is maintained, based on the operating characteristics of the gas-turbine-engine in FIG. 5. The function f5 is obtained in advance using the graph in FIG. 5, and stored in the ROM of the engine control ECU 40 as the function or the map used to determine the total air flow amount Ga based on the speed N1.

In step 153, the engine control ECU 40 calculates the turbine-side air flow amount Gt. The turbine-side air flow amount Gt is calculated by performing the turbine-side air flow amount Gt calculation subroutine described above.

In step 154, the engine control ECU 40 calculates the extraction flow amount Gc. As shown in FIG. 4, part (extraction flow amount Gc) of the compressed air produced by the compressor 11 is obtained from the extraction pipe 15 and used as an engine output, and the remaining (the turbine-side air flow amount Gt) compressed air is introduced to the combustion chamber 12 to form an air-fuel mixture to be burned. Accordingly, the extraction flow amount Gc can be calculated by subtracting the turbine-side air flow amount Gt calculated in step 153 from the total air flow amount Ga calculated in step 152 (Gc←Ga−Gt).

In step 155, the engine control ECU 40 calculates the corresponding-engine output PS_m. More specifically, the engine control ECU 40 converts the extraction flow amount Gc calculated in step 154 into the output from the gas-turbine-engine 10. The flow amount of the compressed air is converted into the output according to the above-mentioned equation (1). The equation (1) is stored in the ROM of the engine control ECU 40 as the function 4 or the map used to calculate the corresponding-engine output PS_m based on the extraction flow amount Gc, the pressure ratio P3/P0, and the compressor outlet temperature T3. The engine control ECU 40 calculates the corresponding-engine output PS_m using the function f4 or the map (PS_m←f4(Gc, P3/P0, T3)). The function f4 is the inverse function of the above-described function f1, and expressed as follows.

$$\begin{matrix}PS\_m = f 4 ( Gc , P 3 / P 0 , T 3 ) \\ = \frac{J}{75} \cdot Cp \cdot Gc \cdot T 3 \{ 1 - \frac{1}{{( \frac{P 3}{P 0} )}^{\frac{κ - 1}{κ}}} \}\end{matrix} \qquad ( 4 )$$

In the equation (4), “J” indicates the mechanical equivalent, “Cp” indicates the specific heat, “κ” indicates the ratio of specific heat, P3/P0 indicates the pressure ratio, T3 indicates the compressor outlet temperature, Gc indicates the extraction flow amount, and PS_m indicates the corresponding-engine output.

In step 156, the engine control ECU 40 calculates the aircraft required output PS_t. More specifically, the engine control ECU 40 calculates the aircraft required output PS_t by adding the corresponding-engine output PS_m calculated in step 155 to the other engine output PS_o detected in step 151 (PS_t←PS_m+PS_o).

The engine control ECU 40 calculates the aircraft required output PS_t, after which the subroutine ends.

Thus, the engine control ECU 40 can determine the aircraft required output. Sequentially performing step 603 and following steps in FIG. 6 and the subroutines based on the aircraft required output makes it possible to set the target speed such that each gas-turbine-engine 10 outputs half the aircraft required output. As a result, the two gas-turbine-engines 10 operate at the same speed under the constant pressure ratio control, and the outputs produced by the two engines become equal to each other. Accordingly, durability, reliability and redundancy of the two gas-turbine-engines 10 can be ensured.

The embodiments of the invention that have been disclosed in the specification are to be considered in all respects as illustrative and not restrictive. The technical scope of the invention is defined by claims, and all changes which come within the meaning and range of equivalency of the claims are therefore intended to be embraced therein. In the embodiments described above, the control apparatus for an aircraft provided with two gas-turbine-engines has been described. However, the number of the gas-turbine-engines is not limited to two. The same control as in the above-described embodiments can be performed in an aircraft provided with more than three gas-turbine-engines.

What is claimed is:

1. A control apparatus for an aircraft, comprising:
multiple gas-turbine engines;
extraction pipes through which compressed air from the respective gas-turbine engines flows;
an air collecting pipe in which the compressed air from the extraction pipes is gathered and through which the compressed air flows;
a thrust generating device that generates thrust using the compressed air flowing through the air collecting pipe;
an attitude control device that controls attitude of the aircraft using the compressed air flowing through the air collecting pipe;
a thrust flow-amount control device that controls an amount of compressed air supplied to the thrust generating device;
an attitude flow-amount control device that controls an amount of compressed air supplied to the attitude control device;
an aircraft control unit that controls the thrust flow-amount control device and the attitude flow-amount control device based on a thrust control signal and an attitude control signal; and
engine control units that are provided to the respective gas-turbine engines, that receive the thrust control signal, and that control the respective gas-turbine engines based on the thrust control signal received.

2. The control apparatus for an aircraft according to claim 1, wherein
the engine control units perform control based on the thrust control signal such that an engine load is distributed evenly between the gas-turbine engines.

3. The control apparatus for an aircraft according to claim 2, wherein
the engine control units control the respective gas-turbine engines such that the gas-turbine engines operate at a same speed and a same pressure ratio between the compressed air and an atmospheric pressure.

4. A control apparatus for an aircraft, comprising:
multiple gas-turbine engines;
extraction pipes through which compressed air from the respective gas-turbine engines flows;
an air collecting pipe in which the compressed air from the extraction pipes is gathered and through which the compressed air flows;
a thrust generating device that generates thrust using the compressed air flowing through the air collecting pipe;
an attitude control device that controls attitude of the aircraft using the compressed air flowing through the air collecting pipe;
a thrust flow-amount control device that controls an amount of compressed air supplied to the thrust generating device;
an attitude flow-amount control device that controls an amount of compressed air supplied to the attitude control device;
an aircraft control unit that controls the thrust flow-amount control device and the attitude flow-amount control device based on a thrust control signal and an attitude control signal; and
engine control units that are provided to the respective gas-turbine engines, that exchange engine control signals with each other, and that control the respective gas-turbine engines based on the engine control signals from all the engine control units.

5. The control apparatus for an aircraft according to claim 4, wherein
the engine control units perform control based on the engine control signals such that an engine load is distributed evenly between the gas-turbine engines.

6. The control apparatus for an aircraft according to claim 5, wherein
the engine control units control the respective gas-turbine engines such that the gas-turbine engines operate at a same speed and a same pressure ratio between the compressed air and an atmospheric pressure.

7. A control apparatus for an aircraft, comprising:
multiple gas-turbine engines;
extraction pipes through which compressed air from the respective gas-turbine engines flows;
an air collecting pipe in which the compressed air from the extraction pipes is gathered and through which the compressed air flows;
a thrust generating device that generates thrust using the compressed air flowing through the air collecting pipe;
an attitude control device that controls attitude of the aircraft using the compressed air flowing through the air collecting pipe;
a thrust flow-amount control device that controls an amount of compressed air supplied to the thrust generating device;
an attitude flow-amount control device that controls an amount of compressed air supplied to the attitude control device;
an aircraft control unit that controls the thrust flow-amount control device and the attitude flow-amount control device based on a thrust control signal and an attitude control signal; and
engine control units that determine a total output produced by the multiple gas-turbine engines, and that control the respective gas-turbine engines based on the total output.

8. The control apparatus for an aircraft according to claim 7, wherein
each of the engine control units determines the total output based on the thrust control signal.

9. The control apparatus for an aircraft according to claim 7, wherein
the engine control units exchange engine control signals with each other, and each of the engine control units determines the total output based on the engine control signals from all the engine control units.

10. The control apparatus for an aircraft according to claim 8, wherein
each of the engine control units determines the output for the corresponding gas-turbine engine based on the total output and the number of the gas-turbine engines.

11. The control apparatus for an aircraft according to claim 9, wherein
each of the engine control units determines the output for the corresponding gas-turbine engine based on the total output and the number of the gas-turbine engines.

12. The control apparatus for an aircraft according to claim 8, wherein
each of the engine control units determines the output for the corresponding gas-turbine engine by dividing the total output by the number of the gas-turbine engines.

13. A control method for an aircraft provided with multiple gas-turbine engines and engine control units that control the respective gas-turbine engines, comprising:
determining, in each of the engine control units, a total output from the multiple gas-turbine engines; and
controlling, using the engine control units, the respective gas-turbine engines based on the total output.

14. The control method according to claim 13, further comprising:
inputting a thrust control signal in each of the engine control units; and
determining, in each of the engine control units, the total output based on the thrust control signal.

15. The control method according to claim 13, further comprising:
exchanging engine control signals between the engine control units; and
calculating the total output based on the engine control signals from all the engine control units.
